(19) United States
(12) Patent Application Publication
(10) Pub. No.: US 2006/0261524 A1
(43) Pub. Date: Nov. 23, 2006

(54) Detection of polymer components using ceramic additive

(76) Inventors: Benjamin G. Hardy, Elkhorn, WI (US); Curt Hagen, Delavan, WI (US); Gary Ferguson, Milton, WI (US); Drew J. VanNorman, Whitewater, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/493,830

(22) Filed: Jul. 27, 2006

Related U.S. Application Data
(63) Continuation-in-part of application No. 11/128,398, filed on May 13, 2005.

(51) Int. Cl. H05B 6/00

(52) U.S. Cl. 264/488

(57) ABSTRACT

A system and method for detecting pieces of polymer components such as food processing equipment components, includes adding a ceramic material to the polymer to form a combined material having metal detectable and/or magnetic removal properties. The item is manufactured out of the combined material, and food products on other material that is processed by processing equipment can be tested using metal detection and/or magnetic removal systems in order to detect and or remove any pieces of the components that may become entrained in the material being processed.

### CROSS-REFERENCE TO RELATED APPLICATIONS

This application claims priority to and is a continuation-in-part of U.S. patent application entitled, X-RAY DETECTION OF POLYMER COMPONENTS IN MATERIAL PROCESSING, filed May 13, 2005, having a Ser. No. 11/128,398, the disclosure of which is hereby incorporated by reference in its entirety.

### FIELD OF THE INVENTION

The present invention relates generally to detection and/or removal of material processing equipment components or pieces thereof in processed materials. More particularly, the present invention relates to detection of polymer material processing components and pieces thereof, in materials such as for example food.

### BACKGROUND OF THE INVENTION

Material processing equipment is in wide use to manufacture a variety of materials and finished products, including for example food products. Some types of such equipment include mixing, pumping and heat transfer devices. One example of such a device is a scraped surface heat exchanger, which has an elongated tube surrounding a central drive shaft. The drive shaft supports radically extending paddles or blades that rotate with the shaft inside the tube. The food material is forced through the tube and is mixed by the paddles, while also changing temperature due to heat or cooling effects provided by the tube. The paddles contact and scrape the inside of the tube as the shaft rotates. Scraped surface heat exchangers also often feature various bearings to support the rotating drive shaft and associated seals provide material sealing.

In the above example, the blades and bearing components have sometimes been made of a metal material. The use of metal materials provides durability, but also has some disadvantages. For example, metal blades tend to wear the inside of the heat exchanger tube due to the relative hardness of the blades relative to the inside surface of the tube. This is undesirable in part because the tube is a major component of the system, while the blades can be relatively easy and inexpensive to replace.

To alleviate this problem, and for other reasons, scraped surface heat exchangers and other food processing devices have replaced many formerly metal components with polymer ones. For example, many scraped surface heat exchangers today use polymer scraper blades, which can economically be formed into special shapes, do not tend to wear the inside of the tube, and which are easily replaced. Thus polymer blades can extend the life of the overall device by extending the life of the tube, which as noted above is a major component. Bearing components have also been implemented in polymer, providing various benefits. Polymer blades, bearings and seals have been developed which meet regulatory requirements. Such blades, bearings and seals are often made of PEEK, PTFE, or polyethylene.

Another concern in the use of food processing devices, such as for example scraped surface heat exchangers, is the purity of contents of the finished foods. Due to increased safety and quality concerns, many food processors are using and seeking out non-destructive testing equipment to monitor the contents of finished and even packaged food products. The food product may be tested at some stage in the overall processing, or even after packaging has occurred. In either case, the processor is viewing the product to ensure that no foreign bodies are present.

The desired result is to be able to detect and then quarantine any food product having undesirable foreign bodies, such as for example processing machinery parts, or to remove the foreign body, so the food product is not delivered to consumers in this condition. Common foreign bodies that may occur include seal parts, nuts, bolts, kettle filings and shavings, miscellaneous metal parts, rubber gaskets, and worn, chipped or even catastrophically failed scraped surface heat exchanger blades. The testing may be done at any point along the processing line, such as just before packaging of the processed material. Alternatively, testing may be done after the product is in its packaging, which may be, for example, polymer packaging, metal packaging or some combination of these. In general, many food processors particularly prefer to test the final packaged product, as opposed to the product directly before packaging, because foreign bodies can enter the product even during its final packaging stage.

The two most prevalent testing methods are metal detectors and x-ray detectors. While metal detection is suitable for metal scraper blades, in recent times many processors have moved to polymer scraper blades as described above to increase the life of their devices. One way to make polymer blades detectable using conventional metal detection testing equipment is to incorporate a metal additive, typically powdered or particulate stainless steel, into the polymer material. This additive can cause accelerated tube wear compared to a purely polymer blade, which counteracts to some extent the benefit of the polymer blade.

Accordingly there is a need in the art for an improved testing system and method, and corresponding components, that can provide detection of polymer contaminant parts in processed materials such as food products, including finished packaged materials such as foods.

### SUMMARY OF THE INVENTION

The present invention in some embodiments provides an improved testing system and method, that can provide detection of the presence and/or condition of polymer components.

In accordance with one embodiment of the present invention, a method for detecting a piece of a polymer item in a processed first material, comprises: adding a ceramic material to a polymer material to form a combined second material; manufacturing the item at least partially out of the combined second material; processing the processed first material using the item; applying metal detection and/or magnetic removal equipment to the processed first material to detect and/or remove pieces of the polymer item.

In accordance with another embodiment of the present invention, a system for detecting a piece of a polymer item in a processed first material, comprises: ceramic material added to a polymer material to form a combined second material having metal-detectable properties, the item being manufactured at least partially out of the combined second material; and means for applying metal detection and/or magnetic removal to the processed first material to detect and/or remove pieces of the polymer item.

In accordance with yet another embodiment of the present invention, a manufactured item, comprises a first polymer material; and a second ceramic material provided as an additive to the first polymer material in an amount selected to allow at lest one of metal detection and/or magnetic detection of a piece of the item.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a scraped surface heat exchanger blade according to one preferred embodiment of the invention.

FIG. 2 is a perspective view of a scraped surface heat exchanger blade according to another preferred embodiment.

FIG. 3 is a perspective view of a bearing according to another preferred embodiment.

FIG. 4 is a flow diagram of steps involved in another preferred embodiment.

### DETAILED DESCRIPTION

Some preferred embodiments of the invention can provide an improved system and method, and corresponding components, that can provide detection and/or removal of polymer contaminant parts in processed materials such as products, including materials such as finished packaged foods. Polymer components are manufactured having a ceramic additive, and pieces of the component can be detected in a manufactured product via metal detection and/or magnetic removal equipment. Exemplary preferred embodiments will now be described with reference to the drawing figures in which like elements refer to like parts throughout. This application uses the term polymer to include at least plastics and elastomers.

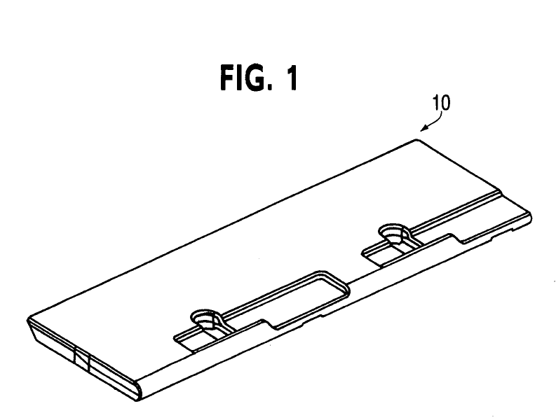

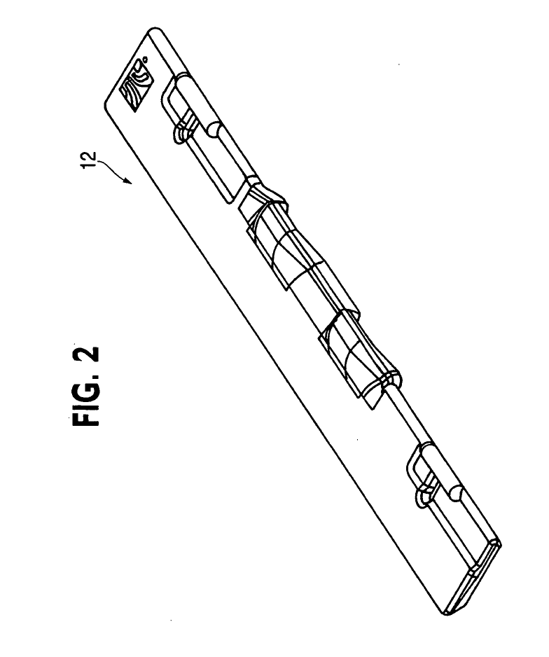

FIGS. 1 and 2 illustrate scraped surface heat exchanger blades designated 10 and 12 respectively. Blade 10 has a relatively simple flat configuration that can be formed by machining from flat polymer stock or by injection molding. Due to its more complex shape, blade 12 is preferably a molded item. Each blade is comprised of a polymer material having a ceramic additive. The polymer blade composition material is preferably PEEK, but may also be any polymer, plastic or elastomer including by way of example PTFE or acetal (polyoxymethylene).

Prior to molding (or other original manufacture process) the material has had added to it in particulate form a ceramic material. Ceramic materials are preferred due to their superior low wearing characteristic, for example, low wear on the inside of a scraped surface heat exchanger tube.

The ceramic material contemplated by these preferred embodiments may include the category of metallic oxides, which are ceramic materials and not metal materials per se. Ceramic materials can also include non-oxide ceramics such as boron nitride, silicon nitride. However, these two materials may be undesirable due to their high hardness, which may cause wear of parts on contact, compared to the other oxide ceramics discussed below.

In this regard, some preferred ceramic materials for addition to the polymer include, but are not limited to, iron oxide, aluminum oxide, cupric oxide, silver oxide, gold oxide, stannic oxide, or nickel oxide. Some of these materials may not be suitable for food applications but could be used in processing equipment for other non-food applications.

One particularly preferred material for addition to the polymer is a ceramic material that is commercially available under the name “PolyMag”™ from the Uriez Company in Erie, Pa. The PolyMag™ additive includes iron oxide and a carrier agent. One benefit of the use of this material is that it results in a manufactured polymer product that in some embodiments can have high temperature resistant or chemical stability, low hardness, non-galling properties, and low cost. Further, iron oxide is presently accepted by the U.S. Food and Drug Administration as a colorant for food processing polymers, and therefore is commercially desirable in this regard as well. It is also noted that many of the ceramic materials discussed above, including the iron oxide additive for example, when used in moving parts, will produce much less wear than would a metallic additive such as stainless steel.

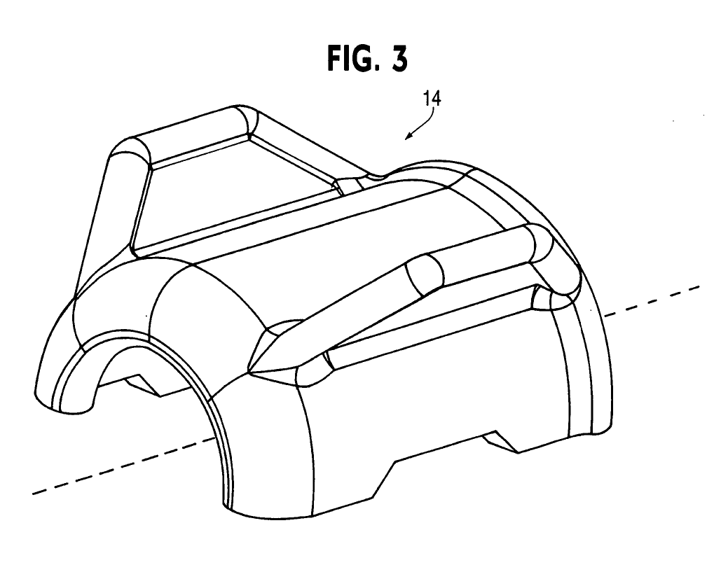

The preferred materials used in the invention can be applied to any polymer-based component of a material processing system. Thus, besides detection of broken components in foods, the invention can provide detection of broken components in other processed materials. Another example is a bearing for a scraped surface heat exchanger such as the illustrated bearing half 14 in FIG. 3. This bearing is made from the same material described above with respect to FIGS. 1 and 2, e.g. a polymer material having ceramic additive.

A significant benefit resulting from the addition of the ceramic material to the polymer components is that pieces of the finished item are detectable by known conventional metal detection systems, and also in some circumstances can be removed by known conventional magnetic removal systems. Therefore, if the formed polymer part having the ceramic additive fails, for example if a chip breaks off of the part, or any other large piece of the part becomes embedded in the material, then at a later stage the material can be tested or checked using either metal detection equipment, magnetic removal equipment, or a combination of both. This application uses the terms item and part and component interchangeably; all of these terms include, but are not limited to, blades, bearings, rotors, impellers, tubes, hinges, seals, or any other item used as part of equipment for food or other material processing.

In this regard, it is noted that the ceramic additive is not a metal material. However, it is detectable by metal detection equipment. Therefore, the benefits of using the metal detector are achieved without incurring the disadvantageous properties of a metal additive, such as the higher wear associated with a metal additive. Further, in the case of ceramic iron oxide, this material has already been approved for use in polymeric food processing components.

This embodiment also achieves the benefits that the piece of the part can be removed from the flow of processed material using magnetic removal equipment. The ceramic material is not a metal, but is attracted by magnetic fields and can be removed using magnetic removal equipment.

One method of forming the final part such as a blade or seal involves adding the ceramic additive to the raw polymer prior to an injection molding or other molding process. In some preferred embodiments, for example, the part may be made from a composite involving 5%-10% iron oxide added to a remainder of PEEK to make a scraper blade, bearing, or seal. Using this percentage ratio of iron oxide results in a blade where the typical wear pattern does not result in harmful, or detectable, amounts of additive (in this example iron oxide) into the food product due to normal wear. However, broken chips or parts of a size that would cause concern are detectable by current conventional metal detection systems.

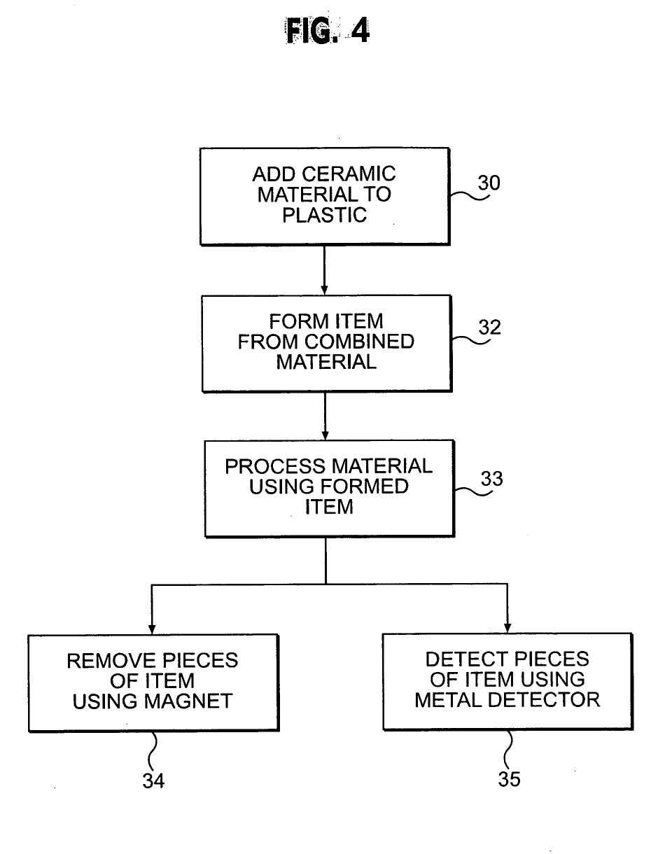

FIG. 4 provides a full diagram of some steps in a preferred embodiment utilizing the invention. At Step 30, the ceramic material is added to the polymer. The polymer and ceramic materials may be any of those described above. At Step 32 an item is formed from the plastic having the ceramic material in it, typically by molding but by any suitable process. At Step 33, a material is processed involving use of the item. For example, the material may be a food item that is being pumped or mixed, and the item may be a scraped surface heat exchanger. Downstream from this processing step, at Step 34 any pieces of the item that may have become entrained in the material being processed can be removed using magnetic removal equipment. Also at Step 35 any pieces of the item that may have become entrained in the material being processed can be detected using a metal detector. Upon detection of these undesirable pieces, the material can be quarantined and inspected or just discarded. Depending on the material, and other circumstances, one or both of Steps 34 and 35 may occur.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for detecting a piece of a polymer item in a processed first material, comprising:
adding a ceramic material to a polymer material to form a combined second material;
manufacturing the item at least partially out of the combined second material;
processing the processed first material using the item; and
applying metal detection equipment to the processed first material to detect pieces of the polymer item.

2. The method of claim 1, wherein the processed first material is a food product.

3. The method of claim 1, wherein the item is a component of a food processing equipment device.

4. The method of claim 1, wherein the item is a component of a scraped surface heat exchanger.

5. The method of claim 1, wherein the item is a blade of a scraped surface heat exchanger.

6. The method of claim 1, wherein the manufacturing step includes molding the item using a molding process.

7. The method of claim 1, wherein the polymer material is PEEK.

8. The method of claim 1, wherein the ceramic material includes iron oxide as a component.

9. The method of claim 1, wherein the process does not include the addition of any metal to the combined material.

10. A system for detecting a piece of a polymer item in a processed first material, comprising:
a ceramic material added to a polymer material to form a combined second material having metal-detectable properties, the item being manufactured at least partially out of the combined second material; and
means for applying metal detection to the processed first material to detect pieces of the polymer item.

11. A method for detecting a piece of a polymer item in a processed first material, comprising:
adding a ceramic material to a polymer material to form a combined second material;
manufacturing the item at least partially out of the combined second material;
processing the processed first material using the item; and
applying magnetic removal equipment to the processed first material to remove pieces of the polymer item.

12. The method of claim 11, wherein the processed first material is a food product.

13. The method of claim 11, wherein the item is a component of a food processing equipment device.

14. The method of claim 11, wherein the item is a component of a scraped surface heat exchanger.

15. The method of claim 11, wherein the item is a blade of a scraped surface heat exchanger.

16. The method of claim 11, wherein the manufacturing step includes molding the item using a molding process.

17. The method of claim 11, wherein the polymer material is PEEK.

18. The method of claim 11, wherein the ceramic material includes iron oxide as a component.

19. The method of claim 11, wherein the process does not include the addition of any metal to the combined material.

20. A system for detecting a piece of a polymer item in a processed first material, comprising:
a ceramic material added to a polymer material to form a combined second material, the item being manufactured at least partially out of the combined second material; and
means for applying magnetic removal to the processed first material to remove pieces of the polymer item.

21. A manufactured item, comprising:
a first polymer material; and
a second ceramic material provided as an additive to the first polymer material in an amount selected to allow at least one of metal detection and/or magnetic detection of a piece of the item.

22. The item of claim 21, where the ceramic material includes iron oxide as a component.
